(19) United States
(12) Patent Application Publication
(10) Pub. No.: US 2016/0144446 A1
(43) Pub. Date: May 26, 2016

(54) CONTACT TIP AND RECEIVING ASSEMBLY OF A WELDING TORCH

(71) Applicant: ILLINOIS TOOL WORKS INC., GLENVIEW, IL (US)

(72) Inventors: Robert Joseph Centner, Frankfort, IL (US); Robert Lloyd Warning, Cedar Lake, IN (US)

(21) Appl. No.: 14/549,227

(22) Filed: Nov. 20, 2014

(51) Int. Cl. B23K 9/12; B23K 9/29

(52) U.S. Cl. CPC B23K 9/123; B23K 9/295

(57) ABSTRACT

A method to replace a contact tip in a welding system includes applying a first force toward a neck of a welding torch to remove the contact tip via a quick release mechanism. Additionally, the method includes inserting a new contact tip into the quick release mechanism and applying a second force on the new contact tip toward the neck of the welding torch until the new contact tip is locked in place within the quick release mechanism.

### BACKGROUND

The present disclosure relates generally to welding systems, and, more particularly, to replacement of contact tips in welding torches of the welding systems.

Welding is a process that has increasingly become ubiquitous in various industries and applications. Additionally, as welding has increased in general, automated welding processes are also becoming increasingly popular. With increasing automation in the field of welding, simple designs to meet automation maintenance goals are ever more valuable. For example, automation complexity may decrease as maintenance complexity of the welding systems also decreases.

Therefore, it may be advantageous to provide a mechanism that simplifies replacement of parts that are exposed to significant deterioration. The present subject matter provides a mechanism and methods to improve efficiency in the replacement of contact tips in welding torches via a quick release design.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a method to replace a contact tip in a welding system includes applying a first force within a neck of a welding torch to remove the contact tip via a quick release mechanism. Further, the method includes inserting a new contact tip into the quick release mechanism and applying a second force on the new contact tip toward the neck of the welding torch until the new contact tip is locked in place within the quick release mechanism.

In a second embodiment, a method to replace a contact tip with an automated system includes removing a contact tip of a welding torch by actuating a quick release mechanism via a tip changing station. Further, the method includes inserting a new contact tip into the welding torch by applying pressure on the new contact tip into the welding nozzle toward a neck of the welding torch via the tip changing station.

In a third embodiment, a contact tip for a welding system includes an elongated hollow body including an electrically conductive material. Additionally, the contact tip includes a retention groove disposed near one end of the elongated hollow body, which receives relaxable locking elements.

In a fourth embodiment, a torch system includes a contact tip that is mountable without tools within a quick release mechanism of a welding torch. The contact tip translates between a secured position and a released position within the quick release mechanism. Additionally, the contact tip includes an elongated hollow body including an electrically conductive material. Further, the contact tip includes a retention groove disposed near one end of the elongated hollow body that receives relaxable locking elements of the quick release mechanism.

### DRAWINGS

These and other features, aspects, and advantages of the present disclosure will become better understood when the following detailed description is read with reference to the accompanying drawings in which like characters represent like parts throughout the drawings, wherein:

FIG. 1 is an embodiment of a metal inert gas (MIG) welding system with a power source and a wire feeder;

FIG. 2 is a side view of an embodiment of a welding torch of the MIG welding system of FIG. 1;

FIG. 3 is an exploded view of a portion of the welding torch of FIG. 2;

FIG. 4 is a further exploded view of the portion of the welding torch of FIG. 3;

FIG. 5 is a cross-sectional illustration of the portion of the welding torch of FIG. 3;

FIG. 6 is a schematic representation of an automated contact tip changing station;

FIG. 7 is an embodiment of a contact tip removal and insertion tool; and

FIG. 8 is a flow diagram of a method for replacing a contact tip in the welding torch of FIG. 2 using an automated system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

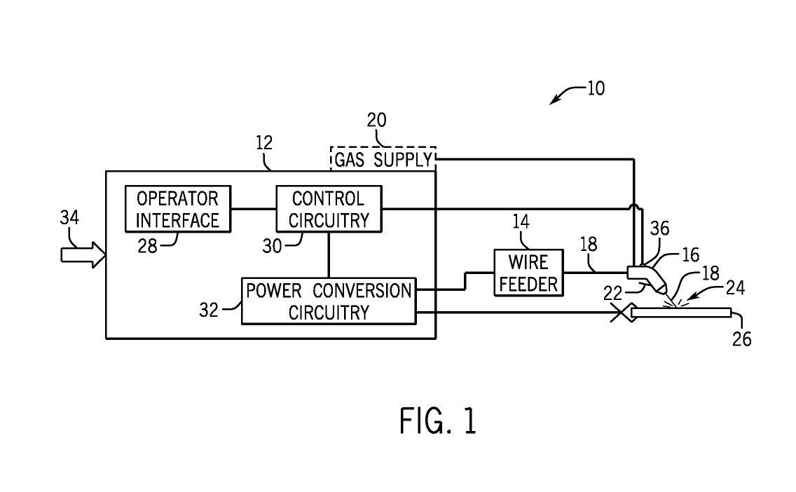

Turning now to the drawings, and referring first to FIG. 1, an exemplary welding system 10 is illustrated as including a power source 12 coupled to a wire feeder 14. In the illustrated embodiment the power source 12 is separate from the wire feeder 14, such that the wire feeder 14 may be positioned at some distance from the power source 12 near a welding location. However, it should be understood that the wire feeder 14, in some implementations, may be integral with the power source 12. The power source 12 may supply weld power to a torch 16 through the wire feeder 14, or the power source 12 may supply weld power directly to the torch 16. The wire feeder 14 supplies a wire electrode 18 (e.g., solid wire, cored wire, coated wire) to the torch 16. A gas supply 20, which may be integral with or separate from the power source 12, supplies a gas (e.g., CO₂, argon) to the torch 16. An operator may engage a trigger 22 of the torch 16 to initiate an arc 24 between the electrode 18 and a work piece 26. In some embodiments, the welding system 10 may be triggered by an automation interface, including, but not limited to a programmable logic controller (PLC) or robot controller. The welding system 10 is designed to provide welding wire (e.g., electrode 18), weld power, and shielding gas to the welding torch 16. As will be appreciated by those skilled in the art, the welding torch 16 may be of many different types, and may facilitate use of various combinations of electrodes 18 and gases.

The welding system 10 may receive data settings from the operator via an operator interface 28 provided on the power source 12. The operator interface 28 may be incorporated into a faceplate of the power source 12, and may allow for selection of settings such as the weld process (e.g., stick, TIG, MIG), the type of wire to be used, voltage and current settings, transfer mode (e.g., short circuit, pulse, spray, pulse), and so forth. In particular, the welding system 10 allows for MIG welding (e.g., pulsed MIG) with electrodes 18 (e.g., welding wires) of various materials, such as steel or aluminum, to be channeled through the torch 16. The weld settings are communicated to control circuitry 30 within the power source 12.

The control circuitry 30 operates to control generation of welding power output that is applied to the electrode 18 by power conversion circuitry 32 for carrying out the desired welding operation. In some embodiments, the control circuitry 30 may be adapted to regulate a pulsed MIG welding regime that may have aspects of short circuit transfer and/or of spray transfer of molten metal from the welding wire to a molten weld pool of a progressing weld. Such transfer modes may be controlled during operation by adjusting operating parameters of current and voltage pulses for arcs 24 developed between the electrode 18 and the work piece 26.

The control circuitry 30 is coupled to the power conversion circuitry 32, which supplies the weld power (e.g., pulsed waveform) that is applied to the electrode 18 at the torch 16. The power conversion circuitry 32 is coupled to a source of electrical power as indicated by arrow 34. The power applied to the power conversion circuitry 32 may originate in the power grid, although other sources of power may also be used, such as power generated by an engine-driven generator, batteries, fuel cells or other alternative sources. Components of the power conversion circuitry 32 may include choppers, boost converters, buck converters, inverters, and so forth.

The control circuitry 30 controls the current and/or the voltage of the weld power supplied to the torch 16. The control circuitry 30 may monitor the current and/or voltage of the arc 24 based at least in part on one or more sensors 36 within the wire feeder 14 or torch 16. In some embodiments, a processor 38 of the control circuitry 30 determines and/or controls the arc length or electrode extension based at least in part on feedback from sensors 36. The arc length is defined herein as the length of the arc between the electrode 18 and the work piece 26. The processor 38 determines and/or controls the arc length or electrode extension utilizing data (e.g., algorithms, instructions, operating points) stored in a memory 40. The data stored in the memory 40 may be received via the operator interface 28, a network connection, or preloaded prior to assembly of the control circuitry 30. Operation of the power source 12 may be controlled in one or more modes, such as a constant voltage (CV) regulation mode in which the control circuitry 30 controls the weld voltage to be substantially constant while varying the weld current during a welding operation. That is, the weld current may be based at least in part on the weld voltage. Additionally, or in the alternative, the power source 12 may be controlled in a current control mode in which the weld current is controlled independent of the weld voltage. In some embodiments, the power source 12 is controlled to operate in a constant current (CC) mode where the control circuitry 30 controls the weld current to be substantially constant while varying the weld voltage during a welding operation.

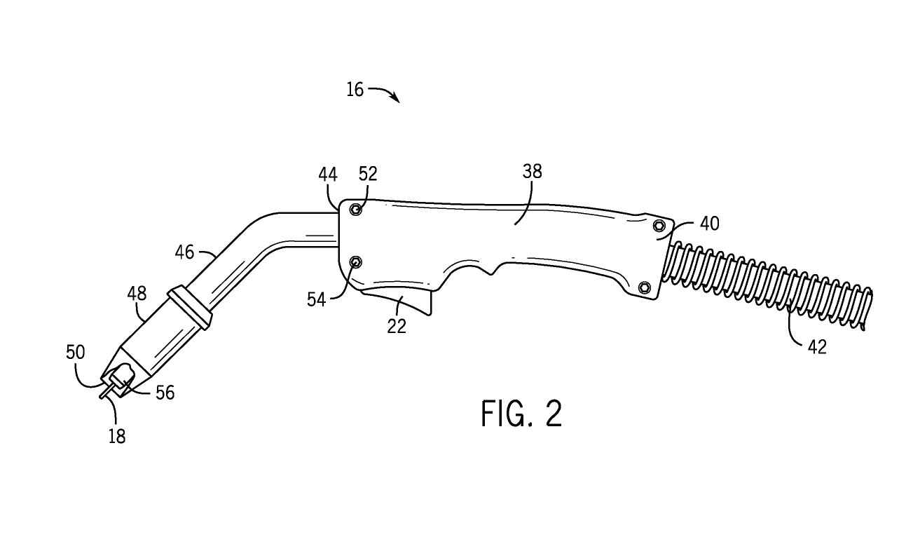

FIG. 2 illustrates an embodiment of the torch 16 of FIG. 1. As discussed in relation to FIG. 1, the torch 16 includes the trigger 22 for initiating a weld and supplying the electrode 18 to the weld. Specifically, the trigger 22 is disposed on a handle 38. A welding operator holds the handle 38 when performing a weld. At one end 40, the handle 38 is coupled to a cable 42 where welding consumables are supplied to the weld. Welding consumables generally travel through the handle 38 and exit at an end 44, which is disposed on the handle 38 at an end opposite from end 40.

The torch 16 includes a neck 46 extending out of the end 44. As such, the neck 46 is coupled between the handle 38 and a welding nozzle 48. As should be noted, when the trigger 22 is pressed or actuated, welding wire travels through the cable 42, the handle 38, the neck 46, and the welding nozzle 48, so that the welding wire extends out of an end 50 (i.e., torch tip) of the welding nozzle 48. Further, as illustrated in FIG. 2, the handle 38 is secured to the neck 46 via fasteners 52 and 54, and to the cable 42 via fasteners 52 and 54. The welding nozzle 48 is illustrated with a portion of the welding nozzle 48 removed to show the electrode 18 extending out of a contact tip 56.

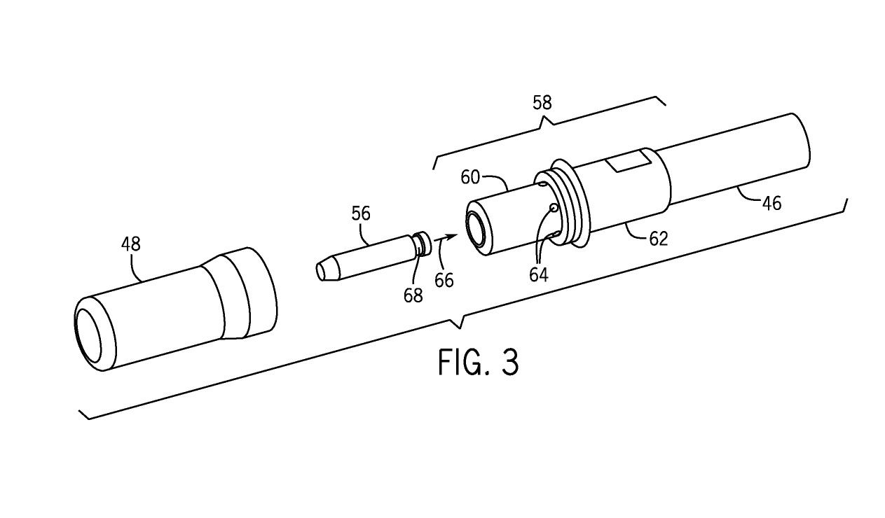

FIG. 3 is an exploded view of a portion of the welding torch 16. Included in this illustration is a quick release mechanism 58. The quick release mechanism 58 quickly connects and disconnects the contact tip 56 during replacement, provides mechanical coupling to the torch 16 for the contact tip 56, and provides electrical coupling to the power source 12 for the contact tip 56, as discussed in detail below. Further, the quick release mechanism 58 includes an insulating sleeve 60 that provides insulation for the contact tip 56 during welding operation. Additionally, the welding nozzle 48 attaches to the welding torch 16 at an attachment interface 62. The attachment interface 62 may include threads corresponding to threads on the welding nozzle 48 to facilitate securement of the welding nozzle 48 to the welding torch 16 and around the quick release mechanism 58.

Furthermore, the insulating sleeve 60 may include gas-through ports 64 to facilitate movement of shielding gas to the welding site. The insulating sleeve 60 may also function as an actuation point for the quick release mechanism 58. Upon applying pressure to the insulating sleeve 60 in an axial direction 66, a locking mechanism relaxes resulting in ejection of the contact tip 56 from the welding torch 16. Prior to relaxing the locking mechanism, a retention groove 68 interacts with locking beads of the locking mechanism to secure the contact tip 56. It may be appreciated that in the illustrated embodiment, the retention groove 68 is substantially constant and extends around the entire circumference of the contact tip 56. Accordingly, the contact tip 56 may be inserted into the quick release mechanism 58 with any orientation. However, in other contemplated embodiments, the retention groove 68 may extend only partially around the circumference of the contact tip 56, or the retention groove 68 may include a series of several recesses surrounding the contact tip 56 where each of the recesses interacts with an individual locking bead. Further, it may be appreciated that the locking beads may include any locking element capable of interacting with the retention groove 68 to retain the contact tip 56.

It may be appreciated that the insulating sleeve 60 may not come into contact with the welding nozzle 48. In this manner, both the insulating sleeve 60 and the welding nozzle 48 may experience an increase in working life expectancy. Additionally, the insulating sleeve 60 is not integrated with the welding nozzle 48. Therefore, should the insulating sleeve 60 wear out, only the insulating sleeve 60 is replaced, while the welding nozzle 48 is reused.

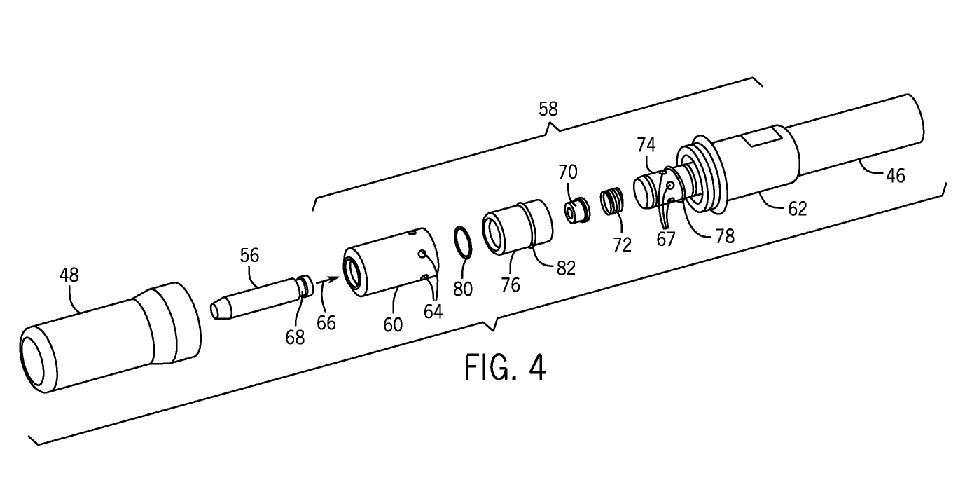

FIG. 4 is a further exploded view of the portion of the welding torch 16 illustrated in FIG. 3. The exploded view of FIG. 4 provides additional detail into mechanics of the quick release mechanism 58 that secures the contact tip 56. For example, locking beads 67 (i.e., locking elements) are illustrated. The locking beads 67 interact with a retention groove 68 in the contact tip 56. When the locking beads 67 are in a locked position, the locking beads 67 are displaced from a relaxed position into the retention groove 68 of the contact tip 56. When in the retention groove 68, the locking beads 67 are held in place by the locking mechanism to prevent removal of the contact tip 56.

Further, the quick release mechanism 58 includes an ejector 70 and a spring 72 to receive a base of the contact tip 56. The ejector 70 interacts directly with the base of the contact tip 56 upon applying force in the direction 66 on the contact tip 56. Additionally, the spring 72, when the contact tip 56 is in the locked position, provides force on the contact tip 56 in an axial direction opposite the direction 66. Because of this, upon the locking beads 67 reaching the relaxed position, the contact tip 56 ejects from the welding torch 16 without a user applying force to the contact tip 56 away from the welding torch 16.

Additionally, an inner part 74 of the locking mechanism provides a retaining area for the locking beads 67. For example, in the illustrated embodiment, the locking beads 67 are placed in bores positioned radially about a circumference of the inner part 74, and a shape of the bores prevents the locking beads 67 from falling through a wall of the inner part 74 when the contact tip 56 is not present within the quick release mechanism 58. Upon placement of the locking beads 67 in the retaining area of the inner part 74, a collar 76 (i.e., an actuator) is positioned over the inner part 74. The actuator 76, as discussed in greater detail below, may lock the locking beads 67 into the retention groove 68 when the actuator 76 is in the locked position, or the actuator 76 may release the locking beads 67 from the retention groove 68 when the actuator 76 is in the relaxed position. Further, a biasing spring 78 fits around the inner part 74 and biases the actuator 76 in the locked position. Therefore, upon applying force in the direction 66 on the actuator 76 via the insulating sleeve 60, the relaxed position is achieved. When the relaxed position is achieved, the contact tip 56 is ejected from the quick release mechanism 58 based on a force of the compressed spring 72.

Moreover, a first retention ring 80 is attached to the inner part 74 upon fitting the actuator 76 over the inner part 74. The first retention ring 80 provides a physical barrier to prevent incidental removal of the actuator 76 when releasing the actuator 76 after ejection of the contact tip 56. Additionally, a second retention ring 82 is affixed to an outer surface of the actuator 76. The second retention ring 82 provides a frictional force on an inner surface of the insulating sleeve 60. The frictional force provided by the second retention ring 82 maintains the insulating sleeve 60 in a position on the actuator, while enabling efficient removal of the insulating sleeve 60 by applying force in a direction opposite the direction 66. Further, the second retention ring 82 may enable removal of the insulating sleeve 60 without the aid of a tool. For example, a user toollessly provides a force on the insulating sleeve 60 in the direction 66 to eject the contact tip 56. The force provided on the insulating sleeve 60 results in the actuator 76 releasing the locking beads 67 from the retention groove 68, and the ejector 70 providing a force to eject the contact tip 56. Additionally, when replacing the contact tip 56, the user may toollessly provide a force on the contact tip 56 into the ejection assembly 58 in the direction 66. The force in the direction 66 on the contact tip 56 results in the contact tip 56 locking within the ejection assembly 58.

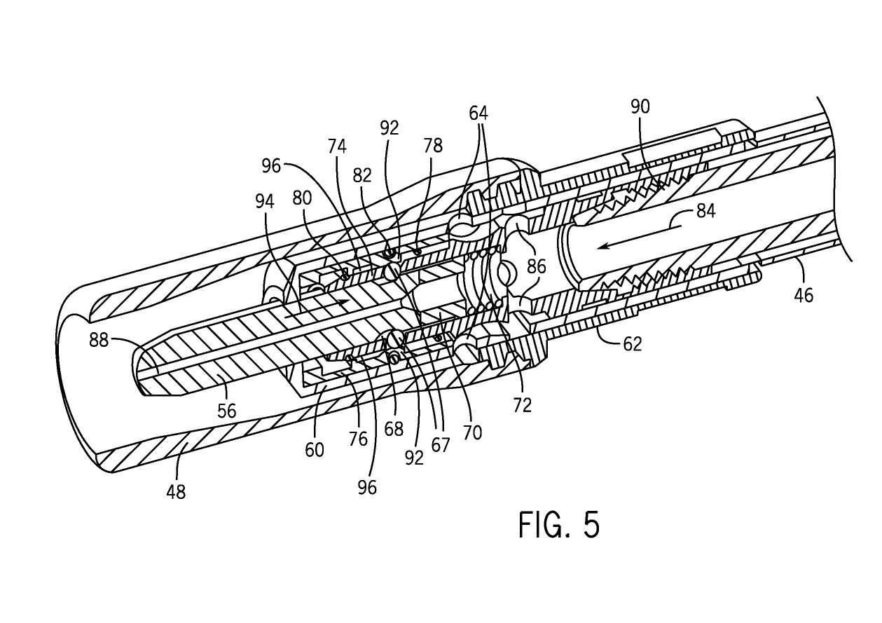

FIG. 5 is a cross-sectional illustration of a portion of the welding torch 16. As illustrated, shielding gas, wire, and current flow through the welding torch 16 in a direction 84. The shielding gas flows from in inner area of the neck 46 toward the welding nozzle 48 to shield the welding location from a surrounding atmosphere that may cause imperfections during a welding process. The shielding gas flows through gas-through ports 86 upon exiting the neck 46, and the shielding gas subsequently flows through the gas-through ports 64 of the insulating sleeve 60 to ultimately exit out of the welding nozzle 48 at the welding location.

Additionally, the wire (i.e., the electrode 18) is fed in the direction 84 toward the welding location. The wire travels through the quick release mechanism 58 and into the contact tip 56. The contact tip 56 includes an elongated body with a hollow interior 88. Further, the hollow interior 88 receives the wire at an interface with the ejector 70 and facilitates transmission of the wire in the direction 84 toward the welding location.

FIG. 5 also provides an illustration of a path in which the current may flow. For example, the attachment interface 62 couples to the neck 46 of the welding torch 16 via threaded regions 90 of the neck 46 and the attachment interface 62. Interaction between the threaded regions 90 enables the flow of current from the neck 46 to the quick release mechanism 58. Upon entering the attachment interface 62, the current travels to the inner part 74 of the locking mechanism. At the inner part 74, the current may have multiple transfer paths to the contact tip 56. For example, the locking beads 67 may be made from a conductive material (e.g., steel) enabling the flow of current through the locking beads 67 into the contact tip 56 which is also made from a conductive material. Because, in the locked position, the locking beads 67 are in contact with both the inner part 74 and the contact tip 56, the flow of current may travel from the inner part 74, through the locking beads 67, and into the contact tip 56 to feed the arc 24. Additionally, the contact tip 56 may receive the flow of current via the ejector 70. As the flow of current enters the inner part 74, the inner part 74 is in contact with the spring 72 and the ejector 70. Therefore, the flow of current may travel from the inner part 74, through the spring 72, to the ejector 70, and into the base of the contact tip 56, and the flow of current may also travel directly from the inner part 74, to the ejector 70, and into the base of the contact tip 56.

Further, the contact tip 56 may also be directly in contact with the inner part 74. When the contact tip 56 is directly in contact with the inner part 74, the flow of current also travels directly from the inner part 74 to any portion of the contact tip 56 in contact with the inner part 74. As such, any one path described above, or any combination of the paths, may provide sufficient contact for adequate current transfer. Additionally, it may be appreciated that while the locking beads 67 are illustrated in FIGS. 4 and 5 with equal spacing around the inner part 74, an asymmetrical placement of the locking beads 67 (i.e., a placement of beads on only one side of the inner part 74) may result in an increase in contact surface area between the contact tip 56 and the inner part 74. In this configuration, the retention groove 68 may be located on only a portion of a circumference of the contact tip 56 that interacts with the asymmetrical placement of the locking beads 67. Such an embodiment may increase the contact surface area between the contact tip 56 and the inner part 74 resulting in enhanced potential to transfer current.

FIG. 5 also illustrates a mechanism for transitioning between the locked position and the relaxed position. As illustrated, the locking mechanism is in the locked position. In the locked position, the locking beads 67 are urged into the retention groove 68 of the contact tip 56 by a ledge 92 disposed on an inner-surface of the actuator 76. The ledge 92 removes space around the locking beads 67 to where there is limited opportunity for movement away from the contact tip 56. However, when a force is applied in an axial direction 94 on the insulating sleeve 60, or, alternatively, directly on the actuator 76, a recess 96 on the inner-surface of the actuator 76 moves over the locking beads 67. When the recess 96 moves over the locking beads 67, the locking beads 67 are forced from the retention groove 68 of the contact tip 56 by a force supplied by the spring 72 on the ejector 70. Once the locking beads 67 depart the retention groove 68 into the recess 96, the contact tip 56 is ejected from the welding torch 16 as a result of the force supplied by the spring 72. Additionally, it may be appreciated that while an ejection is described above relating to FIG. 5, the ejection would also occur in a similar manner after removing the welding nozzle 48. Accordingly, the ejection of the contact tip 56 may occur both with the welding nozzle 48 present and with the welding nozzle 48 absent.

Further, upon ejection of the contact tip 56, the ejector 70 may maintain the locking beads 67 in the relaxed position by continually urging the locking beads 67 into the recess 96 with portions of the ejector 70 in contact with an inner surface of the inner part 74. The relaxed position may be maintained until the contact tip 56 is replaced in the quick release mechanism 58. At this time, the contact tip 56 may urge the ejector 70 in the direction 94 until the locking beads 67 return to the retention groove 68 of the contact tip 56, and the insulating sleeve 60 and the actuator 76 return to the locked position by way of a force provided by spring 78 in the direction 84.

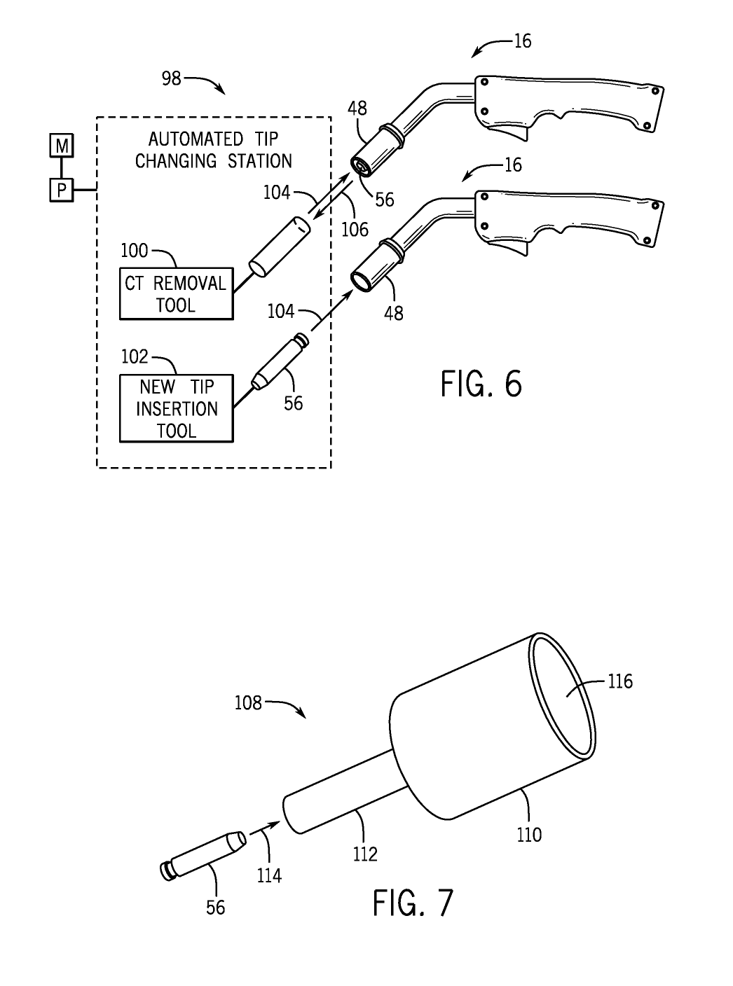

FIG. 6 is a schematic representation of an automated contact tip changing station 98. It may be appreciated that the automated tip changing station 98 may efficiently replace the contact tip 56 of the welding torch 16 in an automated assembly environment. For example, when a welding process is carried out on an assembly line using robotic welding devices, an operator may not be present to replace the contact tip 56 upon significant degradation of the contact tip 56. With this in mind, the present subject matter may be particularly beneficial in the automated assembly environment. The illustrated embodiment of the automated tip changing station 98 includes a contact tip removal tool 100 and a new contact tip insertion tool 102. Additionally, the contact tip removal tool 100 and the new contact tip insertion tool 102 are controlled via a processor P, which receives instructions from a memory M. The processor P may instruct the contact tip removal tool 100 to move in a direction 104 into the welding nozzle 48 to provide a force against the insulating sleeve 60, as discussed above in the discussion regarding FIG. 5. Accordingly, the force provided against the insulating sleeve 60 results in the ejection of the contact tip 56, and the processor P may instruct the contact tip removal tool 100 to retract in a direction 106 (or the welding torch 16 to retract in a direction 104). Further, the processor P may instruct the contact tip removal tool 100 to dispose of the ejected contact tip 56. Conversely, a processor within the robotic welding devices may receive instructions from a memory and control the welding torch 16 to the tip removal tool 100. In such an embodiment, the robotic welding devices may conduct all the movement necessary to actuate the quick release mechanism 58 of the robotic welding devices while the tip removal tool 100 remains stationary.

Additionally, the new tip insertion tool 102 may receive instructions from the processor P to insert the new contact tip 56 into the welding torch 16. The processor P may instruct the new tip insertion tool 102 to move in the direction 104 into the welding nozzle 48 and replace the contact tip 56 into the welding torch 16. The mechanisms locking the contact tip 56 in place are discussed above in the discussion related to FIG. 5. At this point, the welding torch 16 may return to the assembly line with the new contact tip 56 in place. While movement of the new tip insertion tool 102 is described above, it may be appreciated that the new tip insertion tool 102 may remain stationary while the welding torch 16 provides the movement to lock the contact tip 56 in place.

FIG. 7 is an embodiment of a contact tip removal and insertion tool 108. Although the contact tip 56 is removable from the welding torch 16 by hand, the contact tip removal and insertion tool 108 may enable efficient removal and insertion of the contact tip 56. While FIG. 6 illustrated the contact tip removal tool 100 and the new contact tip insertion tool 102 as two separate tools, the contact tip removal and insertion tool 108 combines the two tools 100, 102 into the tool 108 to provide both insertion and removal functions for the contact tip 56. As illustrated, the contact tip removal and insertion tool 108 includes a removal portion 110 and an insertion portion 112. The insertion portion 112 receives a tip of the contact tip 56 after the contact tip 56 is moved in a direction 114 in such a manner that the base of the contact tip 56 extends from an end of the insertion portion 112. The tool 108 inserts the contact tip 56 into the welding nozzle 48 by providing a force in the direction 104 until the contact tip 56 triggers the locking position of the quick release mechanism 58. Further, the tool 108 may be operated as a hand-held tool or as part of the automated tip changing station 98 described above.

In addition to the insertion portion 112, the removal portion 110 may also be used as a hand-held tool or as part of the automated tip changing station 98. The removal portion 110 includes an opening 116. The opening 116 fits around the contact tip as the removal portion 110 applies force to the insulating sleeve 60. Further, a diameter of the removal portion 110 may be of such a size that the removal portion 56 fits in the welding nozzle 48. Because of this, removal of the contact tip 56 may occur without first removing the welding nozzle 48 from the welding torch 16. Once the appropriate amount of force is applied to the insulating sleeve 60, the contact tip 56 ejects from the welding torch into the opening 116. The tool 108 may retain the ejected contact tip 56 in the opening 116 as the tool 108 is removed from the welding nozzle 48.

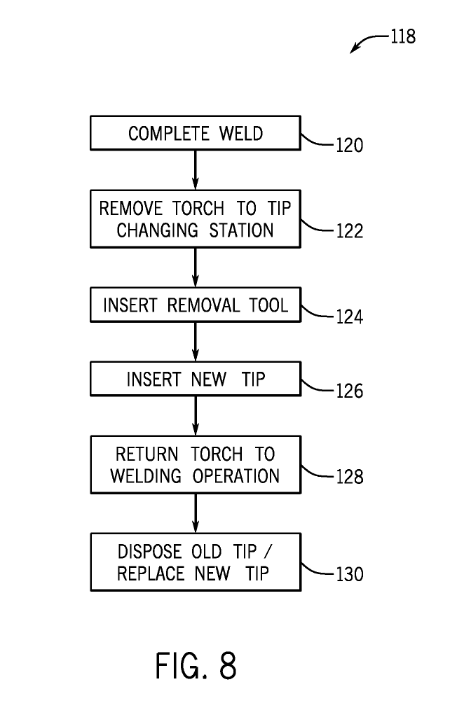

FIG. 8 is a flow diagram of a method 118 for replacing the contact tip 56 using an automated system. Initially, at block 120, the welding torch 16 completes a weld. Upon completion of the weld, a sensor may indicate to the processor P that the contact tip 56 degraded beyond an acceptable level. Because the contact tip 56 operates in a severe environment, the contact tip 56 may wear at a faster rate than other components of the welding torch 16. Therefore, especially in a welding system operated robotically, a simple method for replacing the contact tip 56 with a minimal complexity is desired.

Once the weld is completed and the processor P receives an indication that the contact tip 56 is in a condition for replacement, at block 120, the welding torch 16 is removed to the automated tip changing station 98 at block 122. In some embodiments, the automated tip changing station 98 may service an individual welding torch 16, and the automated tip changing station 98 may be situated directly next to the welding torch 16. In other embodiments, it may be contemplated that the automated tip changing station 98 may service several of the welding torches 16 on an assembly line. In such an embodiment, the automated tip changing station 98 may be positioned in a remote location from the welding torches 16 resulting in the removal of the welding torches 16 from the assembly line for changing of the contact tips 56. In either contemplated embodiment, the quick release mechanism 58 of the welding torch 16 enables the automated tip changing station 98 to replace the contact tip 56 with two actions discussed below.

First, at block 124, the contact tip removal tool 100 is inserted into the welding nozzle 48, and force is applied by the contact tip removal tool 100 on the insulating sleeve 60. The force applied by the contact tip removal tool 100 results in the contact tip 56 ejecting from the welding torch 16. Upon ejection of the contact tip 56, the contact tip removal tool 100 receives the contact tip 56 for disposal in another location.

Second, at block 126, after the contact tip 56 is removed, the new tip insertion tool 102 inserts the replacement contact tip 56. As discussed above, the contact tip 56 may protrude from an end of the new tip insertion tool 102, and the new tip insertion tool 102 provides force into the welding nozzle 48 until the contact tip 56 trips the quick release mechanism 58 into the locking position. At this point, the contact tip 56 is locked in place and releasable upon repeating the step at block 124.

After block 126, the welding torch 16 is returned to a welding operation at block 128. As discussed above, the method 118 may occur in the vicinity of the welding torch 16, or the welding torch 16 may be moved to another location for replacement of the contact tip 56. Further, as the welding torch 16 returns to the welding operation, the old contact tip 56 is disposed from the contact tip removal tool 100, and a new contact tip 56 is made ready for a subsequent replacement of the contact tip 56. Preparation for the subsequent replacement may be accomplished by inserting the new contact tip 56 into the new tip insertion tool 102 at block 130. In this manner, the automated tip changing station 98 may perform an additional removal of the contact tip 56 immediately upon an indication that the contact tip 56 has degraded.

While only certain features of the subject matter have been illustrated and described herein, many modifications and changes will occur to those skilled in the art. It is, therefore, to be understood that the appended claims are intended to cover all such modifications and changes as fall within the true spirit of the subject matter.

1. A method to replace a contact tip in a welding system, comprising:
applying a first force toward a neck of a welding torch to remove the contact tip via a quick release mechanism;
inserting a new contact tip into the quick release mechanism; and
applying a second force on the new contact tip toward the neck of the welding torch until the new contact tip is locked in place within the quick release mechanism.

2. The method of claim 1, wherein the quick release mechanism is configured to retrofit and replace a non-quick release contact tip mechanism of the welding torch.

3. The method of claim 1, wherein applying the first force to remove the contact tip and applying the second force to insert the new contact tip is accomplished in a toolless manner.

4. The method of claim 1, wherein applying the first force to remove the contact tip and applying the second force to insert the new contact tip is accomplished with a contact tip removal and insertion tool.

5. The method of claim 1, wherein applying the first force to remove the contact tip comprises applying the first force on an insulating sleeve.

6. The method of claim 1, comprising applying a third force to remove an insulating sleeve by drawing the insulating sleeve away from a neck of the welding torch.

7. The method of claim 1, wherein the quick release mechanism comprises locking elements that lock the contact tip in place, and the locking elements are relaxed to a relaxed position upon applying the first force toward the neck of the welding torch.

8. The method of claim 7, wherein the locking elements are forced back to a locking position upon applying the second force on the new contact tip.

9. The method of claim 1, wherein a spring ejects the contact tip from the welding torch upon applying the first force.

10. A method to replace a contact tip with an automated system, comprising:
removing a contact tip of a welding torch by actuating a quick release mechanism via a tip changing station;
inserting a new contact tip into the welding torch by applying pressure on the new contact tip toward a neck of the welding torch via the tip changing station.

11. The method of claim 10, wherein actuating the quick release mechanism comprises applying a force via the tip changing station on the quick release mechanism with a contact tip removal tool.

12. The method of claim 10, wherein actuating the quick release mechanism comprises applying force via the tip changing station on an insulating sleeve with a contact tip removal tool.

13. The method of claim 10, wherein inserting the new contact tip comprises inserting the new contact tip via the tip changing station with a new tip insertion tool.

14. The method of claim 13, comprising:
automatically disposing the contact tip removed from the welding torch; and
replacing the new contact tip in the new tip insertion tool with another contact tip after inserting the new contact tip into the quick release mechanism.

15. The method of claim 10, wherein the quick release mechanism comprises locking elements that lock the contact tip in place, and the locking elements are relaxed to a relaxed position upon actuating the quick release mechanism.

16. The method of claim 15, wherein the locking elements are forced back to a locking position upon applying the pressure on the new contact tip.

17. A contact tip of a welding system, comprising:
an elongated hollow body comprising an electrically conductive material; and
a retention groove disposed near one end of the elongated hollow body configured to receive relaxable locking elements.

18. The contact tip of claim 17, comprising a rear end configured to contact an ejector.

19. The contact tip of claim 17, wherein the elongated hollow body is configured to receive an electrode from a wire drive assembly during a welding operation.

20. The contact tip of claim 17, wherein the elongated hollow body is proportioned to be removable from the welding system without first removing a welding nozzle.

21. The contact tip of claim 17, wherein the retention groove is located on only a portion of a circumference of the elongated hollow body.

22. A torch system, comprising:
a contact tip configured to mount without tools within a quick release mechanism of a welding torch, wherein the contact tip translates between a secured position and a released position within the quick release mechanism, and wherein the contact tip comprises:
an elongated hollow body comprising an electrically conductive material; and
a retention groove disposed near one end of the elongated hollow body that receives relaxable locking elements of the quick release mechanism.
